(19) United States
(12) Patent Application Publication
(10) Pub. No.: US 2009/0057219 A1
(43) Pub. Date: Mar. 5, 2009

(54) Replaceable filter elements including unique interfaces and filtration systems including same

(75) Inventors: Ismail Bagci, Cookeville, TN (US); Mark Wieczorek, Cookeville, TN (US); Charles W. Hawkins, Sparta, TN (US); Abby True-Dahl, Sparta, TN (US); Chad Thomas, Algood, TN (US); Jeff Husband, Cookeville, TN (US); Mark Johnson, Cookeville, TN (US); Ted Loftis, Cookeville, TN (US); Robert A. Bannister, Stoughton, WI (US); Arnaud Le Ven, Ergue Gaberic (FR); Gerard Malgorn, Quimper (FR); Gildas Le Men, Guengat (FR)

Correspondence Address: KRIEG DEVAULT LLP, ONE INDIANA SQUARE, SUITE 2800, INDIANAPOLIS, IN, 46204-2079, US

(73) Assignee: Cummins Filtration IP, Inc.

(21) Appl. No.: 11/899,239

(22) Filed: Sep. 5, 2007

(51) Int. Cl. B01D 29/96; B01D 27/00; B01D 35/30; B01D 27/08

(52) U.S. Cl. 210/232; 210/441; 210/473; 210/474; 210/443

(57) ABSTRACT

One embodiment is a replaceable filter element including a filter media having a first end, a second end and an interior cavity, and an endplate coupled to the first end of the filter media, the endplate including a projection extending from the endplate, the projection including a first portion, a flange and a second portion, the first portion extending from the endplate to the flange, the second portion extending from the flange. Further embodiments, forms, objects, features, advantages, aspects, and benefits shall become apparent from the following description and drawings.

### TECHNICAL FIELD

The technical field relates to replaceable filter cartridges and filtration systems including replaceable filter elements.

### BACKGROUND

Various apparatuses and methods have been utilized by the prior art for removing suspended contaminants from a contaminated fluid. In general, the contaminated fluid is passed through a porous filtering media by an external pressure or an external force. The pore size of the porous filtering media is selected to permit the passage of the fluid therethrough while inhibiting the flow of contaminants through the porous filtering media. The contaminants are blocked by the porous filter media while the fluid passes through the porous filter media. The fluid flowing through the filter media is purged of the contaminants.

Replaceable filter cartridges and assemblies have proven to be useful components of filtration systems for a variety of applications including, for example, internal combustion engines such as diesel engines. Replaceable filter elements can be coupled with other components of filtration systems to provide assemblies operable to remove particulates and other undesirable matter from fluids.

There is a need for the unique and inventive replaceable filter elements and filtration systems including replaceable filter elements disclosed herein.

### SUMMARY

In another embodiment of the present invention there is a replaceable filter element comprising a filter media having a first end, a second end, and an interior cavity. The filter element further includes an endplate connected to the first end of the filter media. The endplate including a projection extending from the endplate away from the filter media. The projection has a first portion, a flange and a second portion. The first portion extends from the endplate to the flange. The second portion extends from the flange.

In one refinement of the embodiment the endplate further includes a plurality of ribs extending from the endplate.

In another refinement of the embodiment further comprising a second endplate connected to the second end of the filter media.

In another refinement of the embodiment the replaceable filter element is inserted into a filtration system housing and covered by a filtration system lid. The projection extends through an opening in the lid. The flange of the projection couples the filter element and the lid.

In another refinement of the embodiment the endplate includes a sealing flange having a pair of axially extending circumferential ribs that are radially spaced apart from each other.

In another refinement of the embodiment the lid engages the housing and a force between the lid and the housing forms a seal between the endplate and the housing.

In another refinement of the embodiment a far end of the projection includes means for providing an indication to a user.

In another embodiment of the present invention there is an apparatus comprising a replaceable filter element. The filter element includes a filter media having a first end and a second end. The filter element further includes a closed endplate connected to the first end of the filter media, and means for coupling the replaceable filter element to a lid.

In one refinement of the embodiment the means for coupling the replaceable filter element to a lid includes a projection extending from the endplate. The projection includes a distal portion with an identification mark.

In another refinement of the embodiment the projection is a frustoconical projection that includes a first portion, a flange and a second portion. The first portion extends from the endplate to the flange, the second portion extends from the flange.

In another refinement the embodiment further comprises a lid. The replaceable filter element is coupled to the lid by the flange of the projection.

In another refinement of the embodiment a second endplate is connected to the second end of the filter media. The closed endplate is connected to the first end of the filter media and includes a sealing flange radially outward from the filter media and having a pair of axially extending circumferential ribs that are radially spaced apart.

In another refinement of the embodiment the closed endplate further includes a plurality of radial ribs that protrude axially away from the filter media.

In another refinement of the embodiment the second endplate defines a centrally positioned opening.

In another embodiment of the present invention there is a method of replacing a replaceable filter element in a filtration system including a housing, a replaceable filter element and a lid, the replaceable filter element being inserted into the housing and coupled to the lid, the lid being coupled to the housing. The method comprises decoupling the lid and the housing. The method further comprises removing the lid and the replaceable filter element from the housing, the lid and the replaceable filter element being coupled during the removing. The method further comprises decoupling the replaceable filter element and the lid.

In one refinement of the embodiment the method further comprises coupling the lid and a second replaceable filter element.

In another refinement of the embodiment the method further comprises coupling the lid and the housing, the lid and the second replaceable filter element being coupled during the coupling.

In another refinement of the embodiment the method further comprises decoupling the lid from the housing includes rotating the lid relative to the housing.

In another refinement of the embodiment the decoupling the replaceable filter element and the lid includes applying force to a projection of the replaceable filter element which extends through an opening in the lid.

In another refinement of the embodiment the decoupling consists essentially of applying force to a projection of the replaceable filter element which extends through an opening in the lid.

In another embodiment of the present invention there is a replaceable filter cartridge comprising a substantially annular filter media extending along an axis and defining an internal cavity. The filter media is sandwiched between a closed top endcap and a bottom endcap. The top endcap has a bottom end and top end. The top end has a substantially centrally positioned axially extending appendage. At least a portion of the bottom end is adjacent to the filter media. The bottom end defining a sealing flange.

In one refinement of the embodiment the sealing flange includes a pair of axially extending circumferential ribs, the circumferential ribs being spaced apart from one another radially.

In another refinement of the embodiment the top end includes a plurality of radial ribs that extend axially away from the filter media. The appendage has a distal portion with an indicator mark.

In another refinement of the embodiment the bottom endcap defines a centrally positioned aperture.

Further embodiments, forms, objects, features, advantages, aspects, and benefits shall become apparent from the following description and drawings.

### BRIEF DESCRIPTION OF THE FIGURES

FIG. 1 is a perspective view of a replaceable filter element.

FIG. 2 is a perspective view of a filtration system lid.

FIG. 2A is an alternate view of FIG. 2.

FIG. 3 is a perspective view of a portion of a filtration system housing.

FIG. 4 is a perspective view of a filtration system.

FIGS. 5 and 5A are sectional views of portions of FIG. 4.

FIG. 6 is a perspective view of a filtration system lid and housing.

FIG. 7 is a sectional view of a filtration system.

FIG. 8 is a sectional view of a filtration system.

FIG. 9 is a side view of a vehicle including an engine and a filtration system.

### DETAILED DESCRIPTION

For purposes of promoting an understanding of the principles of the invention, reference will now be made to the embodiments illustrated in the figures and specific language will be used to describe the same. It will nevertheless be understood that no limitation of the scope of the invention is thereby intended, such alterations and further modifications in the illustrated embodiments, and such further applications of the principles of the invention as illustrated therein being contemplated as would occur to one skilled in the art to which the invention relates.

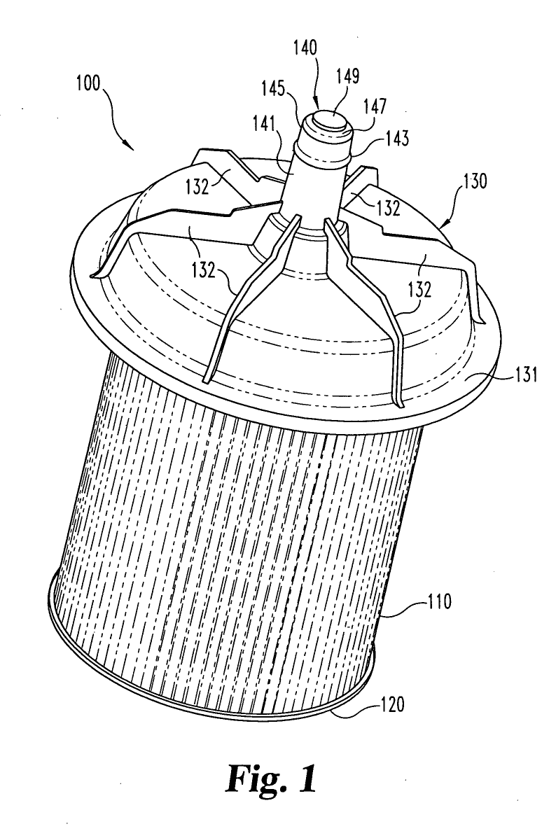

With reference to FIG. 1 there is illustrated a preferred replaceable filter element or cartridge 100 including filter media 110, endplate 120 connected to one end of filter media 110, and endplate 130 connected to another end of filter media 110. In the illustrated embodiment, filter media 110 is a substantially annular and pleated configuration extending from a first end to a second end and defining an interior cavity. In the illustrated embodiment, filter media 110 is preferably sandwiched between and embedded within endplate 120 and endplate 130. Other embodiments contemplate other filter media configurations including, for example, stack disc bypass filter media configurations or other filter media configurations.

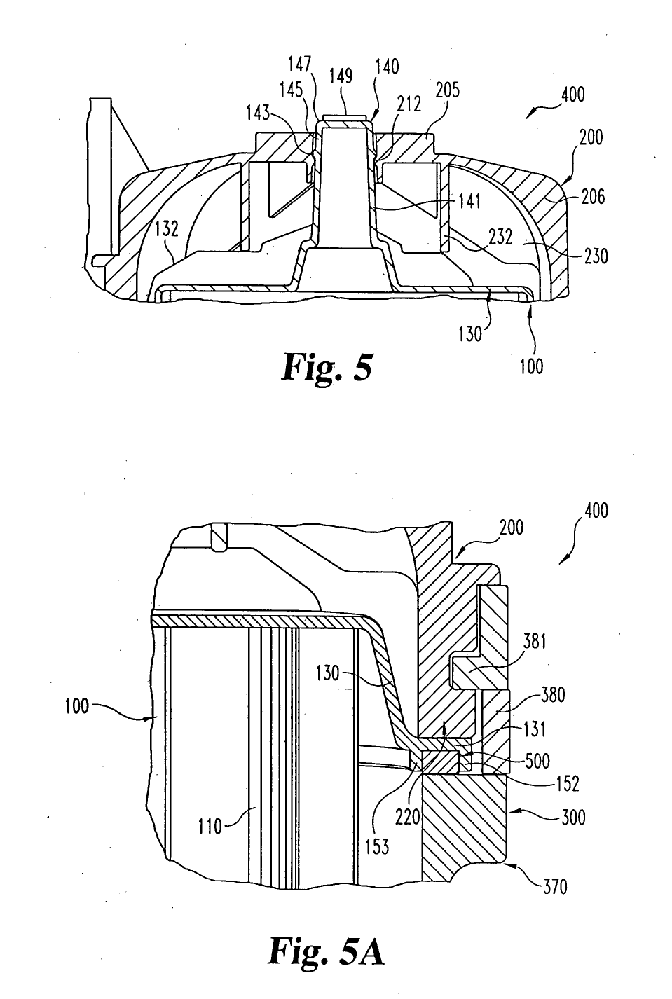

Endplate 130 preferably includes a peripheral sealing flange 131 that extends radially outward. Flange 131 provides sealing capabilities to endplate 130, further details of which are discussed below with respect to FIG. 5A. Endplate 130 also preferably includes ribs 132 that extend axially from endplate 130 away from filter media 110. Ribs 132 provide structural reinforcement and force transfer capabilities to endplate 130. As illustrated in other figures described herein, a circular rib 232 on the internal surface of the lid sits atop the ribs 132 and pushes them down. This assists in providing a uniform seal via, for example, a face seal provided by the combination of the housing and its interface with concentric axially extending radially outer rib 152 and radially inner rib 153 of sealing flange 131 (see FIG. 5A).

Endplate 130 also includes a male protrusion 140 which extends from endplate 130. A portion 141 of protrusion 140 extends from endplate 141 to a flange 143. Another portion 145 of protrusion 140 extends from flange 143 to an end or tip 147 of protrusion 140. Tip 147 preferably includes a visual and/or tactile indicator 149. A wide variety of information might be provided on tip 147. Examples of such information include part number, the original equipment manufacturer (such as a logo or trademark), performance rating of filter (such as a filtration level of 10 microns, 20 microns, etc.), or other information relating to the type or model of replaceable filter element 100, or other information regarding replaceable filter element 100 useful to the customer or user. In one embodiment, protrusion 140 has a generally frustoconical shape. A variety of other shaped projections are also contemplated as within the scope of the invention including, but not limited to, cylindrical. Endplate 130 is preferably a unitary structure formed of a composite or plastic material such as thermoplastic. Other embodiments contemplate that endplate 130 could be formed of multiple pieces coupled together, for example, protrusion 140 and/or other portions of replaceable filter element 100 could be a separate piece coupled to endplate 140.

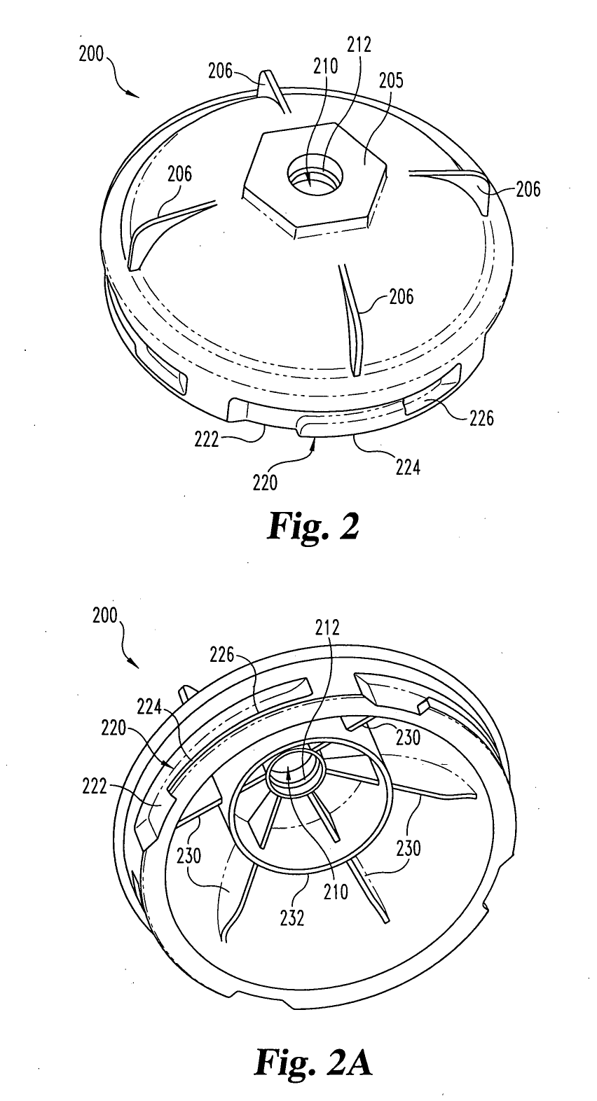

With reference to FIGS. 2 and 2A there is illustrated a preferred filtration system lid 200. Lid 200 includes an aperture 210 that preferably further includes a flange 212 on its interior surface. Lid 200 also includes rotational locks 220 including recesses 222, lips 224, and recesses 226. Lid 200 further includes ribs 230 and ring 232 extending from the interior surface of lid 200, and hex nut 205 and ribs 206 extending from the exterior surface of lid 200.

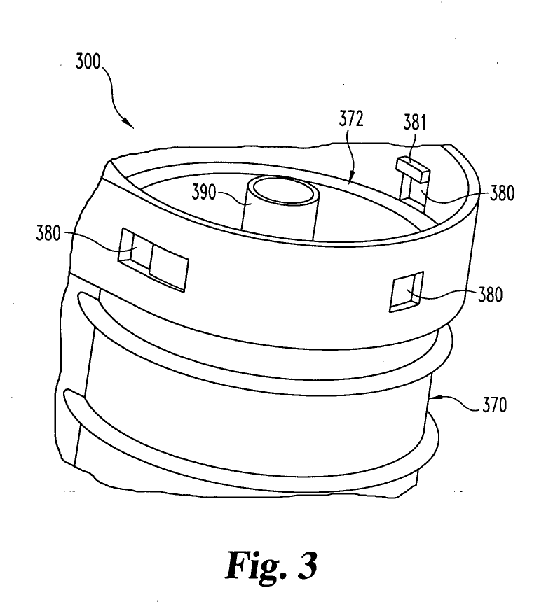

With reference to FIG. 3 there is illustrated a portion of filtration system housing 300 including body 370 surrounding a receptacle 372 and a center post 390. A number of openings 380 and associated tabs 381 are also included in housing 300.

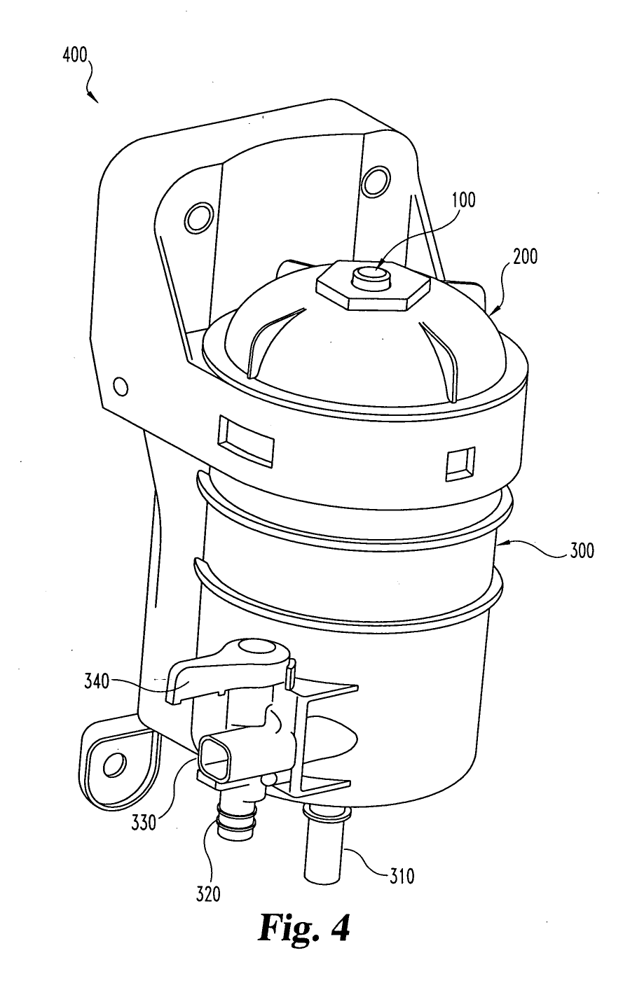

With reference to FIG. 4 there is illustrated a filtration system 400 including housing 300, lid 200 coupled to housing 300, and replaceable filter element 100 positioned within housing 300 and coupled with lid 200. Housing 300 includes an inlet (not illustrated) for unfiltered fluid, an outlet 310 for filtered fluid, drain outlet 320, drain valve 340, and electrical input 330, which could provide one or more power circuit elements operable, for example, to power a heating element (not illustrated) and one or more information circuit elements operable, for example, to send and/or receive information to one or more sensors (not illustrated). The coupling of lid 200 and replaceable filter element 100 includes projection 140 extending though opening 210, for example, as illustrated and described below in connection with FIG. 5. The coupling of lid 200 and housing 300 includes the mating of tabs 381 and locks 220, for example, as further illustrated in FIG. 5A, and may include other couplings, for example, threaded couplings, sealing ridges on a lid or housing, additional rotating locking couplings, bayonet-type couplings, detent couplings, or snap couplings, or combinations and variations of the foregoing and other couplings.

With reference to FIG. 5 there is illustrated a section view of a portion of system 400 illustrating the interfacing of replaceable filter element 100 and lid 200. Replaceable filter element 100 and lid 200 have been positioned with ribs 132 contacting ring 232, and projection or appendage 140 extending though opening 210. Flanges 212 and 143 have been coupled, for example, by application of force sufficient to cause the flanges to slide past one another to the illustrated position. Flanges 212 and 143 preferably provide a seal effective up to a predetermined pressure, after which pressure release may occur. A portion of projection including end 147 and indicator 149 extends from the lid 200 a selected distance, for example, a distance sufficient to provide a means of decoupling flanges 212 and 143 by the application of a decoupling force, permitting separation of lid 200 and replaceable filter element 200. Additional decoupling structures are contemplated, for example, interference fits, snap fits, displaceable elements, deformable elements, threaded elements, latch elements, or combinations and variations of the foregoing.

With reference to FIG. 5A there is illustrated a section view of a portion of system 400 illustrating the interfacing of lid 200 and housing 300. As stated above, tabs 381 have mated and are retained by locks 220. The coupling of lid 200 and housing 300 preferably provides a predetermined force operable to form a seal 500 between replaceable filter element 100 and housing 300 by lid 200, for example by sealing flange 131 being forced toward a housing 300. Sealing flange 131 includes two downwardly extending concentric axial ribs, a radially outer rib 152 and a radially inner rib 153. These ribs preferably snap fit around a corresponding portion of housing 300 to form a seal 500.

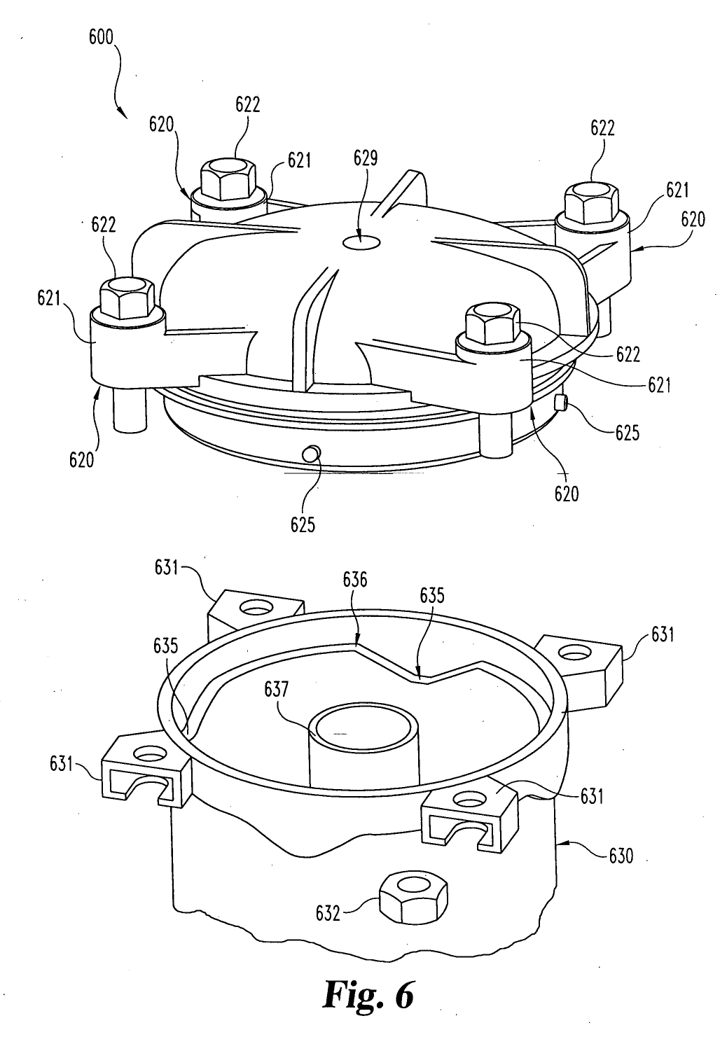

With reference to FIG. 6 there are illustrated filter system lid 600 and filter system housing 630. Filter system lid 600 includes an opening 629 formed therein which could be the same or similar to the openings in filter system lids 200 described above. Filter system lid 600 also includes fastening elements 620 which includes fastener 622 that pass through retaining members 621. Filter system lid 600 also includes alignment pins 625 which are operable to align lid 620 with housing 630. Filter system housing 630 includes the receptacle 636 and an outlet in the form of a substantially hollow center post 637. Housing 630 also includes alignment contour 635 which is operable in connection with alignment posts 625 to align lid 600 relative to housing 630. By rotating the lid 600 to the left or the right, the posts 625 are axially displaced upward by contact with the alignment contour 635 of housing 630. Thus, the substantially V-shaped alignment contour permits easier separation of the lid 600 from the housing 630 by rotation of the lid. Housing 630 also includes fastening elements 631 which receive nuts such as nut 632 that can couple with fasteners 622.

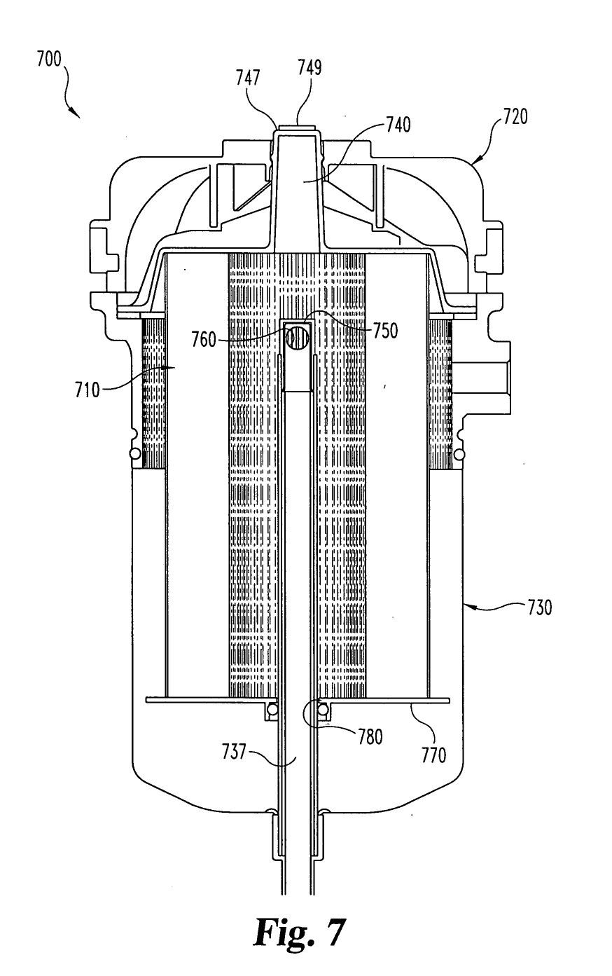

With reference to FIG. 7 there is illustrated a filter system 700 which includes a replaceable filter element 710, a lid 720, and a housing 730. Replaceable filter element 710 including a protrusion 740 that extends axially toward an end 747 that preferably includes a visual indicator 749. Housing 700 includes a center tube 737 that extends through an opening 780 in the bottom endplate 770 of an embodiment of the replaceable filter cartridge of the present invention. The filtered fluid outlet in the form of center tube 737 includes a top end 750 with at least one aperture 760 substantially adjacent the top end 750. In embodiments, for example, in which the filter system is a fuel filter system, the extension of the center tube 737 within the replaceable cartridge allows for a means to maintain a precise level of fuel within the housing during initial engine start up. As will be appreciated by those of ordinary skill in the art, various embodiments of the present invention have a closed top endplate in conjunction with a seal such that all fluid (filtered and unfiltered) is beneath the top endplate. Thus, control of the fuel level might also be accomplished with a flat top endplate, rather than a domed top endplate. The domed top endplate permits the center tube 750 to extend even further up the axis. Indeed, it should be understood that it is contemplated as within the scope of the invention that the center tube 750 and the protrusion 740 may be sized such that the center tube 750 extends into a hollow space within the protrusion 740 that is fluidly connected to the internal cavity of the filter media.

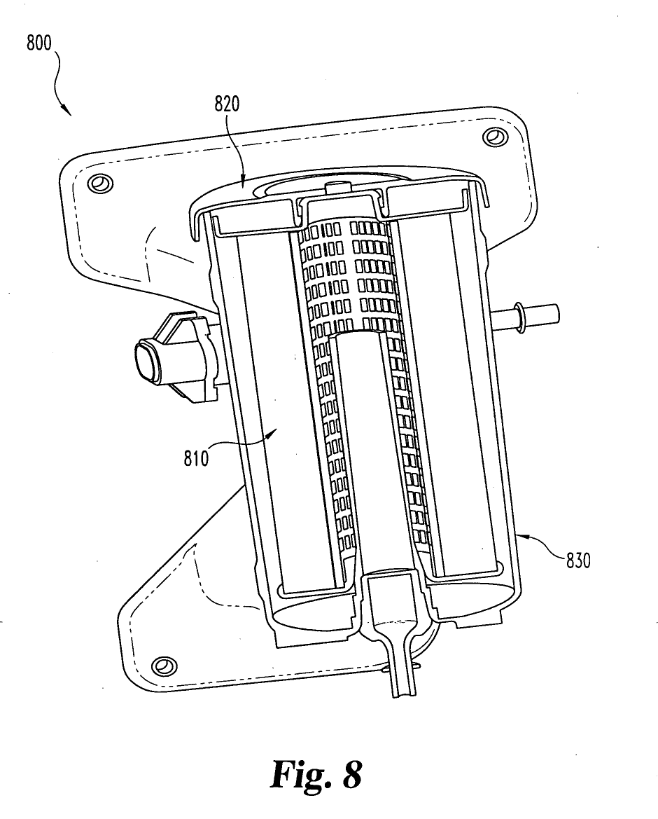

With reference to FIG. 8 there is illustrated a filter system 800 which includes a replaceable filter element 810, a lid 820, and a housing 830. The coupling of replaceable filter elements 710 and 810 with lids 720 and 820, respectively, could be the same or similar to the coupling of replaceable filter element 100 with lid 200 as described above. The coupling of lids 720 and 820 with housings 730 and 830, respectively, could be the same or similar to the coupling of lid 200 with housing 300 as described above. Additional systems are also contemplated. In one additional system, a lid is coupled with a center post, for example, with a pair of engageable threads, and a replaceable filter element can be coupled and decoupled from the lid and center post. There may be one or more projections extending from the filter element, preferably through the lid for facilitating this coupling and/or decoupling.

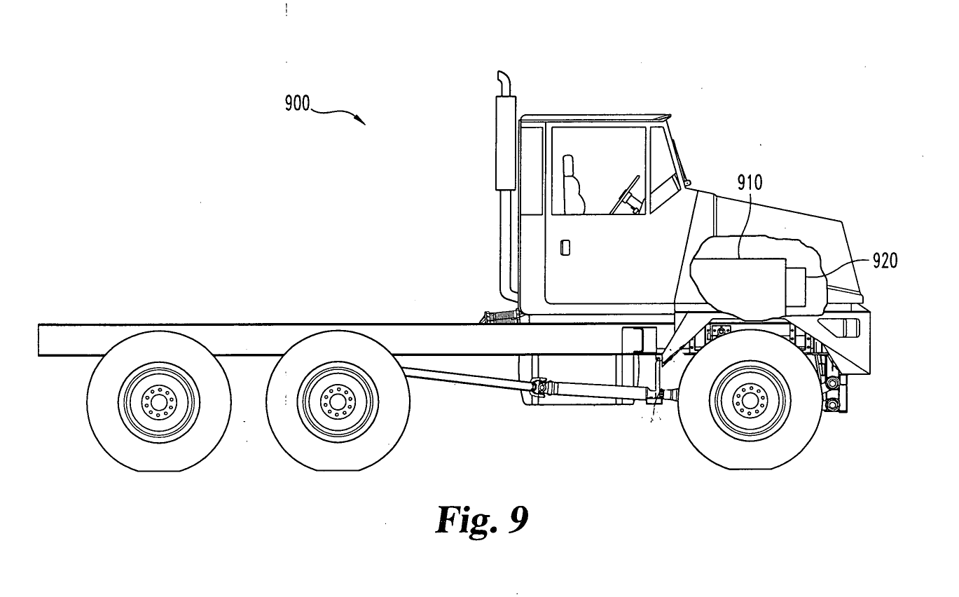

With reference to FIG. 9 there is illustrated a vehicle 900. Vehicle 900 could be a variety of types of vehicles, for example, a light duty truck, a medium duty truck, a heavy duty truck, a passenger vehicle, a bus, or an industrial or construction vehicle. Vehicle 900 includes an engine 910, which is preferably a diesel engine but could be other types of internal combustion engines, and a filtration system 920 which is in flow communication with engine 910 and is operable to filter fluids to be provided to engine 910. Filtration system 920 could be the same as or similar to filtration systems described above.

The present invention relates generally to a combination of a filter cartridge and housing that can be used, for example, with internal combustion engines, such as diesel or gasoline powered engines. Such filter units are important since various fluids used in vehicle engines are susceptible to being contaminated by water, sand, dirt and other particulate materials. Impurities such as products of combustion, soot, moisture, dust, abrasion powder, etc. mix with the lubricating oil every moment during the operation of an automobile's engine and the impurities are filtered by the filter assembly. Thus, there are many applications for filters according to the present invention. For example, the filter assembly can be used for farm equipment, construction equipment, skidders, loaders, other off-road vehicles, heavy-duty highway trucks, automobiles, and other vehicles, industrial machines requiring hydraulic filtering, and all other equipment or mechanical devices that require the filtering of fluids. Additionally, the filter assembly can be used to remove foreign matter from a variety of different fluids. Examples of liquid fluids include hydraulic fluids, engine lubrication oil, diesel fuel, gasoline, engine coolant, automatic transmission fluid, and any other type of fluid. The filter assembly can also be used with gaseous fluids such as air and exhaust.

While exemplary embodiments of the invention have been illustrated and described in detail in the figures and foregoing description, the same is to be considered as illustrative and not restrictive in character, it being understood that only the preferred embodiments have been shown and described and that all changes and modifications that come within the spirit of the invention are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A replaceable filter element comprising:
a filter media having a first end, a second end, and an interior cavity; and
an endplate connected to the first end of the filter media, the endplate including a projection extending from the endplate away from the filter media, the projection including a first portion, a flange and a second portion, the first portion extending from the endplate to the flange, the second portion extending from the flange.

2. A replaceable filter element according to claim 1, wherein the endplate further includes a plurality of ribs extending from the endplate.

3. A replaceable filter element according to claim 1, further comprising a second endplate connected to the second end of the filter media.

4. A replaceable filter element according to claim 1 inserted into a filtration system housing and covered by a filtration system lid; wherein the projection extends through an opening in the lid, and wherein the flange of the projection couples the filter element and the lid.

5. A replaceable filter element according to claim 1, wherein the endplate includes a sealing flange having a pair of axially extending circumferential ribs that are radially spaced apart from each other.

6. A replaceable filter element according to claim 6, wherein the lid engages the housing and force between the lid and the housing forms a seal between the endplate and the housing.

7. A replaceable filter element according to claim 1, wherein a far end of the projection includes means for providing an indication to a user.

8. An apparatus comprising:
a replaceable filter element including
a filter media having a first end and a second end;
a closed endplate connected to the first end of the filter media;
means for coupling the replaceable filter element to a lid.

9. An apparatus according to claim 8, wherein the means for coupling the replaceable filter element to a lid includes a projection extending from the endplate, and the projection includes a distal portion with an identification mark.

10. An apparatus according to claim 9, wherein the projection is a frustoconical projection that includes a first portion, a flange and a second portion, the first portion extending from the endplate to the flange, the second portion extending from the flange.

11. An apparatus according to claim 10, further comprising a lid, the replaceable filter element being coupled to the lid by the flange of the projection.

12. An apparatus according to claim 8, further comprising a second endplate connected to the second end of the filter media, and wherein the closed endplate connected to the first end of the filter media includes a sealing flange radially outward from the filter media and having a pair of axially extending circumferential ribs that are radially spaced apart.

13. An apparatus according to claim 12, wherein the closed endplate further includes a plurality of radial ribs that protrude axially away from the filter media.

14. An apparatus according to claim 13, wherein the second endplate defines a centrally positioned opening.

15. A method of replacing a replaceable filter element in a filtration system including a housing, a replaceable filter element and a lid, the replaceable filter element being inserted into the housing and coupled to the lid, the lid being coupled to the housing, the method comprising:
decoupling the lid and the housing;
removing the lid and the replaceable filter element from the housing, the lid and the replaceable filter element being coupled during the removing; and
decoupling the replaceable filter element and the lid.

16. A method according to claim 15 further comprising coupling the lid and a second replaceable filter element.

17. A method according to claim 16 further comprising coupling the lid and the housing, the lid and the second replaceable filter element being coupled during the coupling.

18. A method according to claim 15 wherein the decoupling the lid from the housing includes rotating the lid relative to the housing.

19. A method according to claim 15 wherein the decoupling the replaceable filter element and the lid includes applying force to a projection of the replaceable filter element which extends through an opening in the lid.

20. A method according to claim 15 wherein the decoupling consists essentially of applying force to a projection of the replaceable filter element which extends through an opening in the lid.

21. A replaceable filter cartridge comprising:
a substantially annular filter media extending along an axis and defining an internal cavity;
the filter media being sandwiched between a closed top endcap and a bottom endcap, wherein the top endcap has a bottom end and top end, the top end having a substantially centrally positioned axially extending appendage, at least a portion of the bottom end being adjacent to the filter media, the bottom end defining a sealing flange.

22. The replaceable filter cartridge of claim 21, wherein the sealing flange includes a pair of axially extending circumferential ribs, the circumferential ribs being spaced apart from one another radially.

23. The replaceable filter cartridge of claim 21, wherein the top end includes a plurality of radial ribs that extend axially away from the filter media, and wherein the appendage has a distal portion with an indicator mark.

24. The replaceable filter cartridge of claim 23, wherein the bottom endcap defines a centrally positioned aperture.
